(19) United States
(12) Patent Application Publication
(10) Pub. No.: US 2016/0209491 A1
(43) Pub. Date: Jul. 21, 2016

(54) RELATIVE DIRECTIONAL ESTIMATION BETWEEN MOBILE ELEMENTS BASED ON RF SIGNALS AND ORIENTATION SENSORS

(71) Applicant: WEFIND-TECH LTD, Tel-Aviv (IL)

(72) Inventors: Ofer KLEIN, TEL-AVIV (IL); Joshua BARBASH, TEL AVIV (IL)

(73) Assignee: WEFIND-TECH LTD, TEL AVIV (IL)

(21) Appl. No.: 14/914,657

(22) PCT Filed: Aug. 21, 2014
(86) PCT No.: PCT/IL14/50749

§ 371 Date: Feb. 26, 2016

Related U.S. Application Data
(60) Provisional application No. 61/870,264, filed on Aug. 27, 2013.

(51) Int. Cl. G01S 5/02

(52) U.S. Cl. CPC G01S 5/0284

(57) ABSTRACT

A system and method thereof for determining direction of relative location having: a first module configured to transmit radio signals; b. a second module having: i. a receiving module configured to receive the radio signals; ii. a non-transitory computer readable medium in communication with the receiving module having instructions thereon for producing distance between the first module and the second module, from the radio signals; and iii. a magnetometer configured to indicate relative direction of movement between the first module and the second module; The instructions are configured to determine direction of relative location of the first module, according to the relative direction and the distance.

### FIELD OF THE INVENTION

The present invention relates to the field of estimating relative direction between two or more electronic devices, more specifically, it focuses on the field of estimating relative direction using distance and orientation parameters.

### BACKGROUND

Children, pets, people that require supervision (elderly persons, prisoners etc) and important or valuable objects may be lost and apart from their intended location either by disorientation, distraction, theft or kidnapping. With the increased concern regarding the above there is a need for relatable and quick methods for tracking some or all of the above that will appropriately alert the relevant persons or authorities.

Conventional methods and systems utilize an expensive and complex dedicated system that in most cases does not allow the average person, especially young children, pet and elderly to use any such system for day to day uses, and usually are limited to expensive devices and a like.

In addition, these systems usually detect the exact location of a person, for example, using two GPS attached to two devices communicating with each other. These devices require high-energy consumption, are expensive and do not have the same accuracy everywhere (for example, indoor or in a bad-reception area).

There is therefore a long unmet need for a system that will be able to give an estimation of a relative direction and location of a person, which is out of a specific range.

### SUMMARY OF THE INVENTION

It is one object of the present invention to provide a system for determining direction of relative location comprising:
   a. a first module configured to transmit radio signals;
   b. a second module comprising:
      i. a receiving module configured to receive said radio signals;
      ii. a non-transitory computer readable medium in communication with said receiving module having instructions thereon for producing distance between said first module and said second module, from said radio signals; and
      iii. a magnetometer configured to indicate relative direction of movement between said first module and said second module;

wherein said instructions are configured to determine direction of relative location of said first module, according to said relative direction and said distance.

It is another object of the present invention to provide the system as defined above, wherein said second module additionally comprising a location module configured to determine location of said second module.

It is another object of the present invention to provide the system as defined above, wherein said instructions are further for finding location of said first module according to said location of said second module.

It is another object of the present invention to provide the system as defined above, wherein said producing distance is according to data selected from a group consisting of: received signals strength indication (RSSI), received signals quality, time of data arrival (TOA) and beam forming.

It is another object of the present invention to provide the system as defined above, wherein said first module additionally comprising a second receiving module.

It is another object of the present invention to provide the system as defined above, wherein said second module configured to transmit radio signals.

It is another object of the present invention to provide the system as defined above, wherein said first module is configured to detect relative direction of movement of said second module.

It is another object of the present invention to provide the system as defined above, wherein said first module and/or said second module additionally comprising a device selected from a group consisting of: accelerometer, Bluetooth radio, WiFi radio, GPS, step counter, Gyro, Zigbee radio, Magnetometer and a combination thereof.

It is another object of the present invention to provide the system as defined above, wherein rate of emission of said radio signals is proportional to rate of location change of said first module.

It is another object of the present invention to provide the system as defined above, further comprising at least one additional said first module.

It is another object of the present invention to provide the system as defined above, further comprising at least one additional said second module.

It is another object of the present invention to provide the system as defined above, wherein rate of emission of said radio signals is proportional to density of one or more said first module and/or one or more said second module.

It is another object of the present invention to provide the system as defined above, wherein said relative direction is in respect to multiple said first module and/or multiple said second module.

It is another object of the present invention to provide the system as defined above, wherein said first module is integrated in a device selected from a group consisting of: mobile device, wearable gadget, computer, laptop and tablet.

It is another object of the present invention to provide the system as defined above, wherein said second module is integrated in a device selected from a group consisting of: mobile device, wearable gadget, computer, laptop and tablet.

It is another object of the present invention to provide the system as defined above, wherein said finding direction of relative location is done by using information of maps, or any other visual display.

It is another object of the present invention to provide the system as defined above, wherein said instructions are additionally for placing relative location of said first module on an interactive map.

It is another object of the present invention to provide the system as defined above, wherein said location is updated according to predetermined parameters.
It is one object of the present invention to provide a method for determining direction of relative location comprising steps of:
   a. transmitting a radio signals form a first module;
   b. providing a second module comprising:
      (i) a receiving module;
      (ii) a non-transitory computer readable medium having instructions thereon; and
      (iii) a magnetometer;
   c. receiving said radio signals by said receiving module;
   d. producing distance between said first module and said second module, from said radio signals, according to said instructions; and
   e. determining relative direction of movement between said first module and said second module using said magnetometer;
   wherein said instructions are further for finding direction of relative location of said first module according to said relative direction and said distance.

It is another object of the present invention to provide the method as defined above, additionally comprising step of providing said second module with a location module configured for determining location of said second module.

It is another object of the present invention to provide the method as defined above, additionally comprising step of finding location of said first module according to said location of said second module.

It is another object of the present invention to provide the method as defined above, wherein said producing distance is according to data selected from a group consisting of: Received signals strength indication (RSSI), Received Signals Quality, time of data arrival (TOA) and beam forming.

It is another object of the present invention to provide the method as defined above, additionally comprising step of providing said first module with a second receiving module.

It is another object of the present invention to provide the method as defined above, additionally comprising step of transmitting a radio signals form said second module.

It is another object of the present invention to provide the method as defined above, additionally comprising step of detecting relative direction of movement of said second module by said first module.

It is another object of the present invention to provide the method as defined above, additionally comprising step of providing said first module and/or said second module with a device selected from a group consisting of: accelerometer, Bluetooth radio, WiFi radio, GPS, step counter, Gyro, Zigbee radio, Magnetometer and any combination thereof.

It is another object of the present invention to provide the method as defined above, wherein rate of emission of said radio signals is proportional to rate of location change of said first module.

It is another object of the present invention to provide the method as defined above, additionally comprising step of proving at least one additional said first module.

It is another object of the present invention to provide the method as defined above, additionally comprising step of proving at least one additional said second module.

It is another object of the present invention to provide the method as defined above, wherein rate of emission of said radio signals is proportional to density of one or more said first module and/or one or more said second module.

It is another object of the present invention to provide the method as defined above, wherein said relative direction is in respect to multiple said first module and/or multiple said second module.

It is another object of the present invention to provide the method as defined above, additionally comprising step of integrating said first module a device selected from a group consisting of: mobile device, wearable gadget, computer, laptop and tablet.

It is another object of the present invention to provide the method as defined above, additionally comprising step of integrating said second module in a device selected from a group consisting of: mobile device, wearable gadget, computer, laptop and tablet.

It is another object of the present invention to provide the method as defined above, wherein said finding direction of relative location is done by using information of maps, or any other visual display.

It is still an object of the present invention to provide the method as defined above, wherein said instructions are additionally for placing relative location of said first module on an interactive map.

It is lastly an object of the present invention to provide the method as defined above, additionally comprising step of updating said location according to predetermined parameters.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 describes a system for determining direction of relative location;

FIG. 2 discloses a flow-chart for a method for determining direction of relative location; and

FIG. 3 describes an illustrated example of the distance and direction of the first module relative to the second module.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The term “server”, refers hereinafter to any physical hardware device configured to communicate with electronic devices and store data. It may also relate to different disconnected hardware devices at different locations, these hardware devices maybe in partial or full communication with each other.

The term “computer readable medium (CRM)”, refers hereinafter to any non-transitory medium that is capable of storing or encoding a sequence of instructions for execution by a computer and that cause the computer to perform any one of the methodologies of the present invention, it includes, but is not limited to, solid-state memories, optical and magnetic disks, and carrier wave signals.

The term “Magnetometer”, refers hereafter to any scientific instrument that measure the strength and/or direction of a magnetic field. Typically, magnetometers measure a magnetic field or flux density in metric units of gauss (G) or the international system (IS) unit tesla (T). A non limiting example for a magnetometer is “Overhauser magnetometer” which incorporates an electron-rich liquid combined with hydrogen and subjected to a radio frequency (RF) signal. In the presence of this signal, the unbound electrons in the liquid transfer to the protons of the hydrogen nuclei; the resultant energy transfer polarizes the liquid. The precession frequency is linear with the magnetic flux density and thus can be used to measure it.

The term “sub-giga RF” refers hereinafter to radio frequency below 1000 KHz.

The term “Dash7” refers hereinafter to an open source wireless sensor networking standard for wireless sensor networking.

The term “Bluetooth” refers hereinafter to a wireless technology standard for exchanging data over short distances (using short-wavelength radio transmissions in the ISM band from 2400-2480 MHz) from fixed and mobile devices.

The term “WiFi” refers hereinafter to the technology that allows an electronic device to exchange data or connect to the interne wirelessly using radio waves.

The term “GPS” refers hereinafter to a space-based satellite navigation system that provides location and time information in all weather conditions, anywhere on or near the Earth where there is an unobstructed line of sight to four or more GPS satellites.

The term “zigbee” refers hereinafter to a suite of high level communication protocols used to create personal area networks built from small, low-power digital radios.
It is one object of the present invention to provide a system for determining direction of relative location comprising:
   a. a first module configured to transmit radio signals;
   b. a second module comprising:
      i. a receiving module, configured to receive the radio signals;
      ii. a non-transitory computer readable medium (CRM) in communication with the receiving module having instructions thereon for evaluating and producing distance between the first module and the second module from the received radio signals; and
      iii. a magnetometer configured to indicate relative direction of movement between the first module and the second module;
   wherein the instructions are further are configured to determine direction of relative location of the first module, according to the relative direction and the produced distance.
It is one object of the present invention to provide a method for determining direction of relative location comprising steps of:
   a. transmitting a radio signals form a first module;
   b. providing a second module comprising:
      i. a receiving module;
      ii. a non-transitory computer readable medium (CRM) having instructions thereon; and
      iii. a magnetometer;
   c. receiving the transmitted radio signals by the receiving module;
   d. producing distance between the first module and the second module, from the radio signals, according to the CRM's instructions; and
   e. determining relative direction of movement between said first module and said second module using said magnetometer;
   wherein said instructions are further for finding direction of relative location of said first module according to the relative direction and the distance.

It is an object of the current invention to assist a first user with detection of location of a second user. This can be applied in various situations. For example, a parent is holding a mobile device, and a child is having a bracelet on his hand, which can emit radio signal. The communication between the two devices is limited to a certain radius. Once the child has left this radius, a disconnection alert may pop-up at the parent device.

At this point, the child cannot be located using his bracelet, since he is out of the detection radius of the mobile device. In this scenario, the parent is unable to know where to search for the child. The current invention, in some embodiments, suggests a possible solution in the form of continuously detecting two parameters: (i) distance; and (ii) relative direction. Using these two parameters, once the child is out of range, it is possible to estimate his general direction.

Therefore, the present invention provides a tool for which, once a notification of the child being out of range is received by the mobile device, an additional notification also appears, directing the parent on the direction the child will probably be at.

This may be in some embodiments performed in both directions. That is, once the child understands that he is being lost, he will receive using his device, a notification on the possible direction in which his parent is at.

It should be noted, that for the public, this device would be energy efficient and low-cost, since in its most basic form, it requires just a device configured to emit a radio signals and a smart-phone with a designated application installed on it.

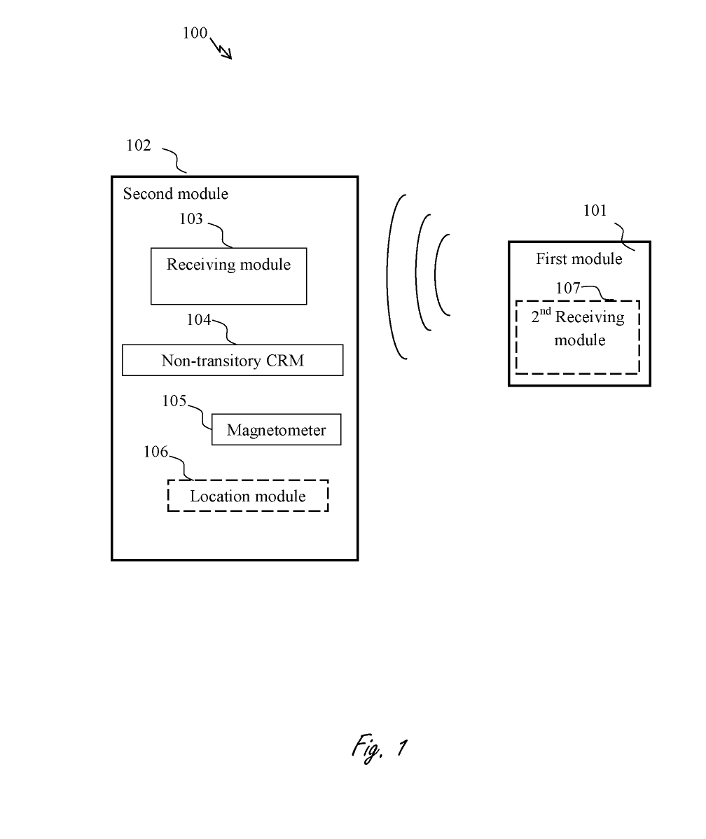

Reference is now made to FIG. 1, illustrating in a non-limiting manner a system 100 for determining direction of relative location comprising:
a. a first module 101 configured to transmit radio signals;
b. a second module 102 comprising:
   i. a receiving module 103 configured to receive the radio signals;
   ii. a non-transitory computer readable medium (CRM) 104 in communication with the receiving module 103 having instructions thereon for producing distance between the first module 101 and the second module 102, from the radio signals; and
   iii. a magnetometer 105 configured to determine relative direction of movement between the first module 101 and the second module 102;
wherein the instruction are further for finding direction of relative location of the first module 101 according to the relative direction and the distance.

In some embodiments of the current invention the system as described above, the second module additionally comprising a location module 106 configured to determine location of the second module.

In some embodiments of the current invention, the instructions are for finding location of the first module according to the location of the second module.

In some embodiments of the current invention, the producing distance is according to data selected from a group consisting of: Received signals strength indication (RSSI), Received Signals Quality, time of data arrival (TOA), beam forming.

In some embodiments of the current invention, the first module additionally comprising a second receiving module 107.

In some embodiments of the current invention, the first module is configured to detect relative direction of movement of the second module.

In some embodiments of the current invention the system as described above, either one of the first module, the second module additionally comprising a device selected from a group consisting of: accelerometer, Bluetooth radio, WiFi radio, GPS, step counter, Gyro, Zigbee radio, Magnetometer and a combination thereof.

In some embodiments of the current invention the system as described above, rate of emission of the radio signals is proportional to rate of location change of the first module.

In some embodiments of the current invention the system as described above, additionally comprises at least one more first module.

In some embodiments of the current invention the system as described above, additionally comprises at least one more second module.

In some embodiments of the current invention, the rate of emission of the radio signals is proportional to density of either one of: one or more the first module, one or more of the second module.

In some embodiments of the current invention the relative direction is in respect to either multiple first modules or multiple second modules.

In some embodiments of the current invention either one of the first module, the second module are integrated in a device selected from a group consisting of: mobile device, wearable gadget, computer, laptop and tablet.

In some embodiments of the current invention the finding direction of relative location is done by using information of maps, or any other visual display.

In some embodiments of the current invention instructions are additionally for placing relative location of the first module on an interactive map.

In some embodiments of the current invention the location is updated according to predetermined parameters.

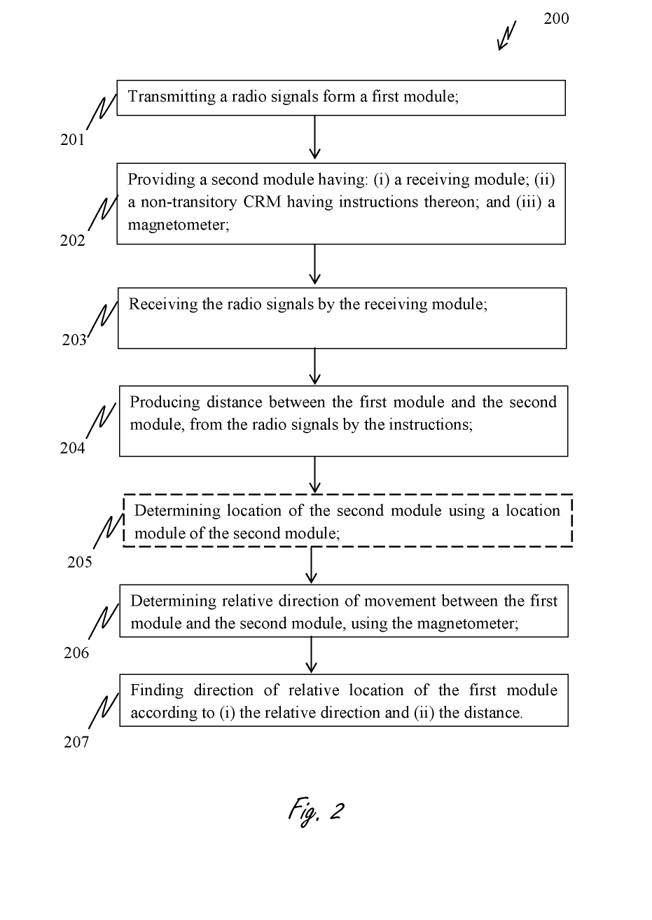

Reference is now made to FIG. 2, illustrating in a non-limiting manner a method 200 for determining direction of relative location comprising:
a. step 201 of transmitting a radio signals form a first module;
b. step 202 of providing a second module comprising: (i) a receiving module; (ii) a computer readable medium having instructions thereon; and (iii) a magnetometer;
c. step 203 of receiving the radio signals by a receiving module located on a second module;
d. step 204 of producing distance of the first module from the second module from the radio signals by the instructions; and
e. step 206 of determining relative direction of movement between the first module and the second module using the magnetometer;
wherein the instruction include step 207 for finding direction of relative location of the first module according to the relative direction and the distance.

In some embodiments of the current invention the method, as described above, additionally comprising step of providing the second module with a location module configured for determining location of the second module. Accordingly in some embodiments, the method may further comprise step 205 for determining location of the second module using the location module.

In some embodiments of the current invention the method, as described above, additionally comprising step of determining location of the first module according to the location of the second module.

In some embodiments of the current invention the step of producing distance is according to data selected from a group consisting of: received signals strength indication (RSSI), received signals quality, time of data arrival (TOA) and beam forming.

In some embodiments of the current invention the method, as described above, additionally comprising step of providing the first module with a second receiving module.

In some embodiments of the current invention the method, as described above, additionally comprising step of detecting relative direction of movement of the second module by the first module.

In some embodiments of the current invention the method, as described above, either one of the first module, the second module additionally comprising a device selected from a group consisting of: accelerometer, Bluetooth radio, WiFi radio, GPS, step counter, Gyro, Zigbee radio, Magnetometer and a combination thereof.

In some embodiments of the current method, as described above, the rate of emission of the radio signals is proportional to rate of location change of the first module.

In some embodiments of the current invention the method, as described above, additionally comprises step of proving at least one more first module.

In some embodiments of the current invention the method, as described above, additionally comprises step of proving at least one more second module.

In some embodiments of the current method, as described above, the rate of emission of the radio signals is proportional to density of either one of: one or more the first module, one or more of the second module.

In some embodiments of the current method, as described above, the relative direction is in respect to either multiple first modules or multiple second modules.

In some embodiments of the current invention the method, as described above, additionally comprises step of integrating either one of the first module, the second module in a device selected from a group consisting of: mobile device, wearable gadget, computer, laptop and tablet.

In some embodiments of the current method, as described above, the finding direction of relative location is done by using information of maps, or any other visual display.

In some embodiments of the current method, as described above, the instructions are additionally for placing relative location of the first module on an interactive map.

In some embodiments of the current invention the method, as described above, additionally comprises step of updating the location according to predetermined parameters.

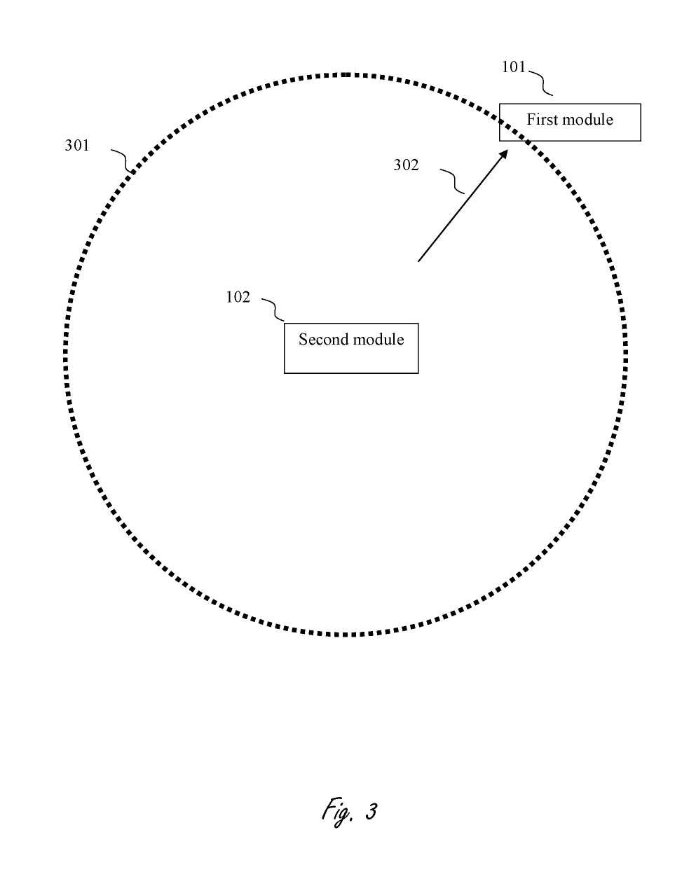

Reference is now made to FIG. 3, illustrating in a non-limiting manner at least one embodiment of the current invention, in which a second module 102 is communicating with the first module 101. The second module 102, can detect the distance 301, therefore, locate the first module 101 on a circle having a radius of the detected distance. The second module 102 may also, using a magnetometer, locate the relative direction 302 of the first module 101. It may therefore, once the first module 101 has lost contact with the second module 102, indicate on the direction in which the first module 101 is heading for.

It will be appreciated by persons skilled in the art that embodiment of the invention are not limited by what has been particularly shown and described hereinabove. Rather the scope of at least one embodiment of the invention is defined by the claims below.

1. A system for determining direction of relative location comprising:
a. a first module configured to transmit radio signals;
b. a second module comprising:
i. a receiving module configured to receive said radio signals;
ii. a non-transitory computer readable medium in communication with said receiving module having instructions thereon for producing distance between said first module and said second module, from said radio signals; and
iii. a magnetometer configured to indicate relative direction of movement between said first module and said second module;
wherein said instructions are configured to determine direction of relative location of said first module, according to said relative direction and said distance.

2. The system according to claim 1, wherein
a. said second module additionally comprising a location module configured to determine location of said second module and
b. said instructions are further for finding location of said first module according to said location of said second module.

3. (canceled)

4. The system according to claim 1, wherein said producing distance is according to data selected from a group consisting of: received signals strength indication (RSSI), received signals quality, time of data arrival (TOA) and beam forming.

5. The system according to claim 1, wherein
a. said first module additionally comprising a second receiving module;
b. said second module configured to transmit radio signals; and
c. said second module is configured to detect relative direction of movement of said first module.

6. (canceled)

7. (canceled)

8. The system according to claim 1, wherein said first module and/or said second module additionally comprising a device selected from a group consisting of:
accelerometer, Bluetooth radio, WiFi radio, GPS, step counter, Gyro, Zigbee radio, Magnetometer and a combination thereof.

9. The system according to claim 1, wherein rate of emission of said radio signals is proportional to rate of location change of said first module.

10. The system according to claim 1, further comprising at least one additional said first module or at least one additional said second module.

11. (canceled)

12. The system according to claims 10, wherein rate of emission of said radio signals is proportional to density of one or more said first module and/or one or more said second module.

13. The system according to claims 10, wherein said relative direction is in respect to multiple said first module and/or multiple said second module.

14. The system according to claim 1, wherein
a. said first module is integrated in a device selected from a group consisting of: mobile device, wearable gadget, computer, laptop and tablet; and
b. said second module is integrated in a device selected from a group consisting of: mobile device, wearable gadget, computer, laptop and tablet.

15-18. (canceled)

19. A method for determining direction of relative location comprising steps of:
a. transmitting a radio signals form a first module;
b. providing a second module comprising:
(i) a receiving module;
(ii) a non-transitory computer readable medium having instructions thereon; and
(iii) a magnetometer;
c. receiving said radio signals by said receiving module;
d. producing distance between said first module and said second module, from said radio signals, according to said instructions; and
e. determining relative direction of movement between said first module and said second module using said magnetometer;
wherein said instructions are further for finding direction of relative location of said first module according to said relative direction and said distance.

20. The method according to claim 19, additionally comprising
a. step of providing said second module with a location module configured for determining location of said second module; and
b. step of finding location of said first module according to said location of said second module.

21. (canceled)

22. The method according to claim 19, wherein said producing distance is according to data selected from a group consisting of: Received signals strength indication (RSSI), Received Signals Quality, time of data arrival (TOA) and beam forming.

23. The method according to claim 19, additionally comprising
a. step of providing said first module with a second receiving module;
b. step of transmitting a radio signals form said second module; and
c. step of detecting relative direction of movement of said first module by said second module.

24. (canceled)

25. (canceled)

26. The method according to claim 19, additionally comprising step of providing said first module and/or said second module with a device selected from a group consisting of: accelerometer, Bluetooth radio, WiFi radio, GPS, step counter, Gyro, Zigbee radio, Magnetometer and any combination thereof.

27. The method according to claim 19, wherein rate of emission of said radio signals is proportional to rate of location change of said first module.

28. The method according to claim 19, additionally comprising step of proving at least one additional said first module or the step of proving at least one additional said second module.

29. (canceled)

30. The method according to claims 28 and/or 29, wherein rate of emission of said radio signals is proportional to density of one or more said first module and/or one or more said second module.

31. The method according to claims 28 and/or 29, wherein said relative direction is in respect to multiple said first module and/or multiple said second module.

32. The method according to claim 19, additionally comprising
a. step of integrating said first module a device selected from a group consisting of: mobile device, wearable gadget, computer, laptop and tablet; and
b. step of integrating said second module in a device selected from a group consisting of: mobile device, wearable gadget, computer, laptop and tablet.

33-36. (canceled)
